(19) United States
(12) Patent Application Publication
(10) Pub. No.: US 2020/0020013 A1
(43) Pub. Date: Jan. 16, 2020

(54) SYSTEM AND METHOD TO CUSTOMIZE USER EXPERIENCE BASED ON BRAND RESILIENCE DATA

(71) Applicant: eBay Inc., San Jose, CA (US)

(72) Inventors: Elizabeth Churchill, San Francisco, CA (US); Hugo Liu, New York, NY (US)

(21) Appl. No.: 16/450,537

(22) Filed: Jun. 24, 2019

Related U.S. Application Data
(63) Continuation of application No. 14/259,056, filed on Apr. 22, 2014, now abandoned.

(51) Int. Cl. G06Q 30/06

(52) U.S. Cl. CPC G06Q 30/0627

(57) ABSTRACT

A system to customize user experience based on brand resilience data is described. An example system includes a new session detector, a session type module, a brand resilience module, and a search strategy selector. The new session detector detects commencement of a user session in the on-line trading platform. The session type module examines the initial search request in a user session and determines whether the initial search request includes a phrase that represents a brand name. The brand resilience module examines brand resilience value assigned to the brand name. The search strategy selector selects, based on the brand resilience value, a search strategy for the user session.

### TECHNICAL FIELD

This application relates to the technical fields of software and/or hardware technology and, in one example embodiment, to system and method to customize user experience based on brand resilience data.

### BACKGROUND

An on-line trading platform allows users to shop for almost anything using, e.g., a web browser application or an application native to a mobile device. A user may find an item listed by an on-line trading application by entering keywords into the search box provided on an associated web page or by browsing through the list of categories on the home page. After reading the item description and viewing the seller's reputation, the user may be able to either place a bid on the item or purchase it instantly. There are many features provided by an on-line trading application that may be utilized by users in unique ways that may result in a successful shopping experience. A user may encounter an item of interest on a web site other than a web site associated with the on-line trading platform. The user may be able to determine keywords that describe that item of interest, access the web site associated with the on-line trading platform and attempt to locate that item in the on-line trading platform.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to customize user experience based on brand resilience data may be implemented;

FIG. 2 is block diagram of a system to customize user experience based on brand resilience data, in accordance with one example embodiment;

FIG. 3 is a flow chart of a method to customize user experience based on brand resilience data, in accordance with an example embodiment;

FIG. 4 is an example scatterplot of points representing brand resilience and the associated regression line; and

FIG. 5 is a diagrammatic representation of an example machine in the form of a computer system, within which a set of instructions, for causing the machine to perform any one or more of the methodologies discussed herein, may be executed.

### DETAILED DESCRIPTION

Method and system are provided to customize user experience based on brand resilience data. In the following description, for purposes of explanation, numerous specific details are set forth in order to provide a thorough understanding of example embodiments. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

According to one example embodiment, data that describes a user's on-line behavior with respect to a particular brand or brands may be used to infer the user's predicted behavior, as well as the user's preferences and tastes with respect to products offered in the on-line trading platform. A brand is typically referenced by a brand name that identifies a type of product manufactured by a particular company under a particular name. An on-line trading platform may be configured to include or to cooperate with a brand resilience system and a brand affinity system. Brand resilience may be viewed as a measure of how likely a user, who started an on-line search for a product characterized by a certain brand name, would be interested in (e.g., searching for, viewing, clicking, buying) items of the initially-searched-for-brand (e.g., Coach©), as opposed to searching for/viewing/clicking/buying items of other brands, in the course of a session in the on-line trading platform. A session may be understood as a continuous interaction with the on-line trading platform for a period of time and without interruptions longer than a predetermined period of time. If an identification of a brand (e.g., a keyword indicative of a brand name) appears in the first search submitted by a user within a given session, the session is considered as a “branded session” or as having brand intent.

The brand resilience value of a brand may be calculated utilizing a brand popularity value of the brand and a brand intent value of the brand. A brand popularity value of a brand may be expressed as a number of searches in the on-line trading platform, over a period of time, that include the brand name. A brand intent value may be expressed as the number of clicks in the on-line trading platform by users, during their respective branded sessions with respect to a particular brand, on references to item listings that include the particular brand name, divided by the number of clicks by the users on references to item listings that include any brand name during their respective branded sessions with respect to the particular brand. Thus, brand_intent (Coach©)=(# of clicks on Coach© items across all user sessions branded “Coach©”)/(# of clicks on any brand items across all user sessions branded “Coach©”). Brand intent may be also referred to as on-brand click percentage of a brand name. A brand intent value, a brand popularity value, and the associated brand resilience value may be calculated based on the data collected for a sample group of users of the on-line trading platform, baaed on data collected over a period of time. Brand resilience may be calculated as follows, Plot all brands in a single domain (for example, fashion) in an x-y scatterplot where x-axis is log(brand popularity) and y-axis is log(brand intent). Calculate the line of regression m(x). Calculate the standard deviation sd. Brands above the line are positively resilient. Brands below the line arc negatively resilient. Calculate resilience(brand)=(y−m(x)/sd=[log_brand_intent(brand)−m(log_brand_popularity(brand))]/sd. Thus, resilience is the number of standard deviations above or below the line of regression. In one example embodiment, resilience value that is greater than 1 may trigger the single-brand-strategy with some confidence, whereas resilience value that is less than −0.5 might trigger the show-alternate-brands strategy.

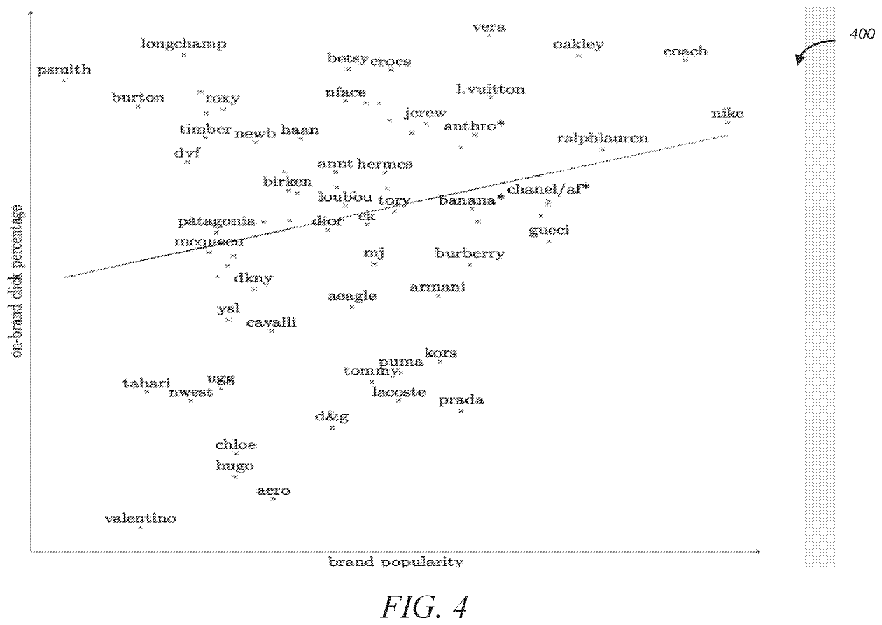

Respective brand resiliencies of a collection of brands may be represented on a graph, with the x axis representing popularity of a brand and the y axis representing on-brand click percentage of a brand name. It has been observed that the greater brand popularity tends to lead to greater on-brand click percentage of a brand. An example scatterplot of points representing brand resilience and the associated regression line 410 are shown in FIG. 4. The points representing brands having greater brand resilience appear above the regression line 410, while the points representing brands having lower brand resilience appear below the regression line 410.

As stated above, brand resilience may be viewed as a measure of how likely a user, who started an on-line search for a product characterized by a certain brand name, would continue to be interested in items of that same brand in the course of a session in the on-line trading platform. For each brand, brand resilience value may be calculated and stored for future user. Brand resilience value may be recalculated periodically or on demand, e.g., when an identification of a brand appears in the first search submitted by a user within a given session, such that the session is considered as a branded session.

Brand resilience value of a brand may be utilized to determine what type of user experience would be best suited for a given user. For example, if a user starts a session in the on-line trading platform with a search request that includes a reference to a highly resilient brand, an inference may be made that the user is unlikely to be interested in items that are not of that exact brand. The user may then be presented only with items of that exact brand. In a branded session, the resilience value of a brand may be used to determine whether to show items of difference brands to the user, in the search results and, also, what portion of the total of the search results should be from other brands. For example, if the brand associated with a branded session is characterized by high resilience, the user may be presented only or predominately with item listings associated with that exact brand. If, on the other hand, the brand associated with a branded session is characterized by low-resilience, the user may be presented with item listings without taking into consideration whether they are associated with that exact brand. For high resilience brands, the user may even be presented with items that are not the same as the items the user is searching for but that are of the same brand. Thus, if Coach® has been identified as a highly resilient brand, indicating that users who shop for Coach® items on-line are not likely to be interested in items from other brands, a user who included “Coach” and “bag” in the search query may be presented with the search results that include Coach® bags and also include other items by Coach®, e.g., Coach® accessories. It may be said that, in a branded session, a user may be presented with different user experiences, based on the determined brand resilience. These different user experiences are determined by different search strategies with respect to the same search request. For example, a search strategy that excludes item listings that do not reference the brand name that appears in the first search request of the branded session may be termed a brand-focused search strategy. A search strategy that does not exclude item listings that do not reference the brand name that appears in the first search request of the branded session may be termed a brand-neutral search strategy.

It will be noted that, in queries, a brand can be referenced by its synonyms, such as the official name, a misspelling, a familiar short name, an abbreviation, etc. To be robust to these variations, an example system to customize user experience based on brand resilience data may be configured to annotate each brand in a list with its popular synonyms.

In one embodiment, brand affinity between brands may also be considered in determining which item listings to present to a user in response to a search query. Brand affinity is a value assigned to a pair of brand identifiers representing respective brands. Brand affinity may be viewed as a measure of correlation between the two brands in terms of user's preference with respect to each of the brands. For example, a high affinity value indicates that users who are interested in one of the brands in the pair are also likely to be interested in the other brand in the pair. Conversely, a low affinity value indicates that users who are interested in one of the brands in the pair are not likely to be interested in the other brand in the pair. Thus, in response to a search that includes a brand name as one of the keywords, a user may be presented with the item listings of items with a brand name that appears in the search query and also with item listings of items with brand names that have greater affinity with, the brand name that appears in the search query. In one embodiment, affinity between two brands may be determined based on correlation of transactions (e.g., purchases) with respect to item listing that include the brand name and transactions with respect to item listings that include the further brand name, by the same user in the on-line trading platform.

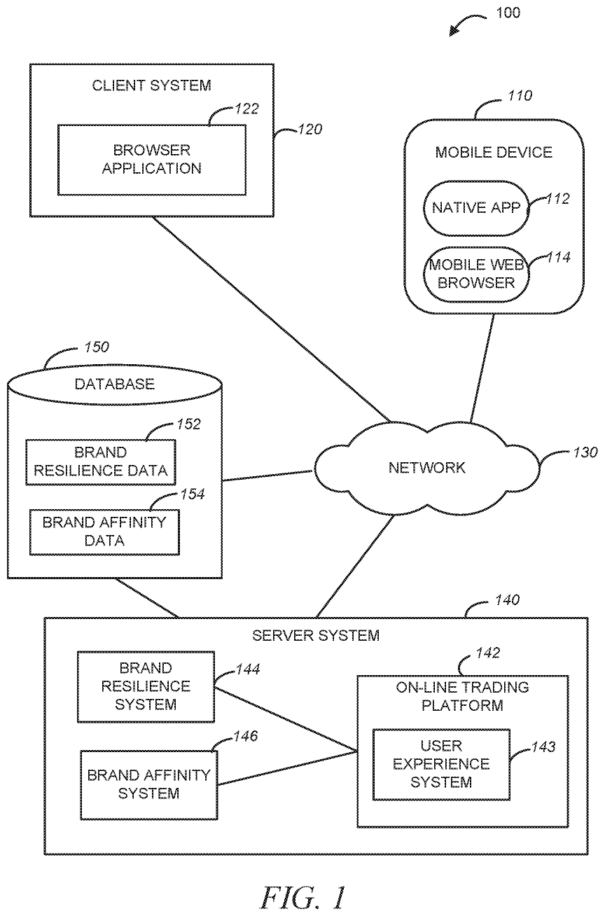

An example method and system to customize user experience based on brand resilience data may be implemented in the context of a network environment 100 illustrated in FIG. 1. As shown in FIG. 1, the network environment 100 may include a client devices 110 and 120, and a server system 140. The client device 110 may be executing a native app 112 and/or a mobile web browser 114. The native app 112 may be providing access to services executing on the server system 140, such as, e.g., to services provided by the on-line trading platform 142. The client devices 110 and 120 may have access to the server system 140 hosting the on-line trading platform 142 via a communications network 130. The communications network 130 may be a public network (e.g., the Internet, a mobile communication network, or any other network capable of communicating digital data).

As shown in FIG. 1, the server system 140 also hosts a brand resilience system 144 and a brand affinity system 146. In one example embodiment, the brand resilience system 144 is configured to determine brand resilience value for a brand name. The brand resilience system 144 may be configured to determine brand resilience value for the brand name as a function of brand popularity value for the brand name and the on-click percentage value for the brand name. The brand popularity value for a brand name may be calculated as a function of a number of searches in the on-line trading platform, over a period of time, that include the brand name. The on-click percentage value for a brand name may be calculated as a number of clicks by a user, during a single session, on references to item listings that include a particular brand name (the focused number of clicks), divided by a total number of clicks by the user, during that same session, on references to item listings that include any brand name. Also shown in FIG. 1 is a user experience system 143, which may be part of the on-line trading platform 142. The user experience system 143 may include some or all of the modules of the brand resilience system 144. As mentioned above, respective brand resilience values for various brand names may be calculated in advance and stored for future use, e.g., in a database 150 as brand resilience data 152. Brand resilience may also be calculated on demand, e.g., in response to detecting the commencement of a branded session in the on-line trading platform 142.

The user experience system 143 may be configured to select search strategy for a user to be utilized in the course of a branded session in the on-line trading platform 142. As explained above, users may be presented with different user experiences based on the brand resilience value associated with a brand name that was detected in the first search of a new user session in the on-line trading platform 144. For example, one version of user experience may be associated with a so-called brand-focused search strategy, which comprises excluding item listings that do not reference the brand name that appears in the first search request of the branded session. Another version of a search strategy is a so-called brand-neutral search strategy, which comprises including, in addition to item listings that reference the brand name that appears in the first search request of the branded session, also those item listings that do not reference the brand name or reference another brand name.

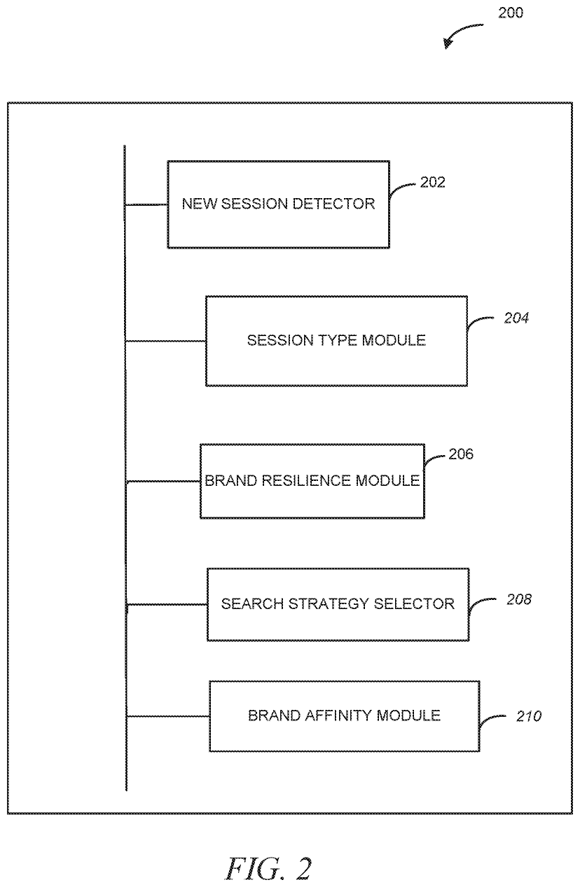

Also shown in FIG. 1 is a brand affinity system 146. As explained above, brand affinity is a value assigned to a pair of brand identifiers (e.g., brand names) representing respective brands, which may be viewed as a measure of correlation between the two brands in terms of user's preference with respect to each of the brands. The brand affinity system 146 may be configured to calculate respective brand affinity values for pairs of brands, based on correlation of transactions (e.g., purchases) with respect to item listing that include the brand name and transactions with respect to item listings that, include the further brand name, by the same user in the on-line trading platform. Brand affinity data generated by the brand affinity system 146 may be stored in the database 150, as brand affinity data 154. The user experience system 143 may include some or all of the modules of the brand affinity system 146. An example system that includes functionality to customize user experience based on brand resilience data is illustrated in FIG. 2.

FIG. 2 is a block diagram of a system 200 to customize user experience based on brand resilience data, in accordance with one example embodiment. As shown in FIG. 2, the system 200 includes a new session detector 202, a session type module 204, a brand resilience module 206, and a search strategy selector 208. The new session detector 202 may be configured to detect commencement of a user session in the on-line trading platform (also referred to as merely a session). The first search request in a new user session is referred to as an initial search request. The presence or the absence of a reference to a brand name in the initial search request is used to identify the session as a branded session or as not a branded session. The session type module 204 may be configured to examine the initial search request in a user session and determine whether the initial search request includes a phrase that represents a brand name. The brand resilience module 206 may be configured to examine brand resilience value assigned to the brand name. The brand resilience value is indicative of the importance of the brand name to users of the on-line trading platform. The brand resilience module 206 may be made capable of calculating brand resilience value for the brand name, either periodically based on a schedule or on demand or, e.g., in response to the initial search request in a user session in the on-line trading platform 142 of FIG. 1. As explained above, the brand resilience value for the brand name may be calculated as a function of brand popularity value for the brand name and the on-click percentage value for the brand name.

The search strategy selector 208 may be configured to select, based on the brand resilience value a search strategy for the user session. As described above, some examples of search strategies include a brand-focused search strategy and a brand-neutral strategy, where the brand-focused search strategy entails presenting item listings associated with the brand name and omitting presenting item listings associated with further brand names that are distinct from the brand name, while the brand-neutral strategy entails presenting item listings associated with the brand name and also presenting item listings associated with one or more further brand names that are distinct from the brand name.

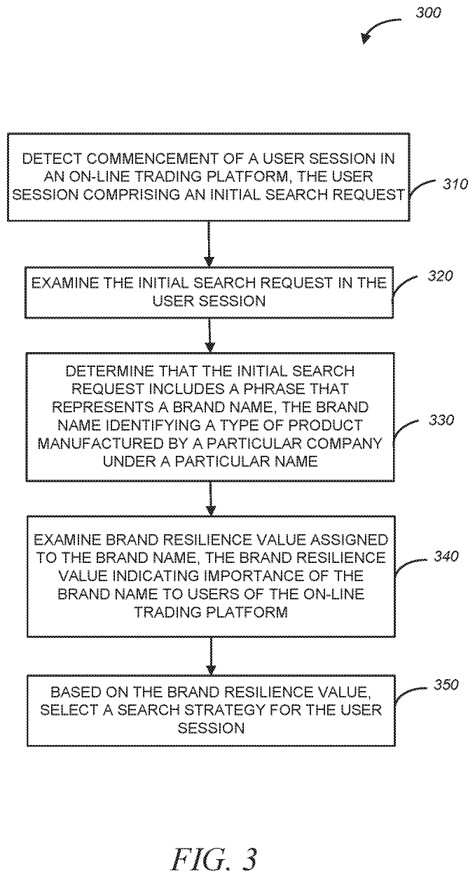

Also shown in FIG. 2 is a brand affinity module 206. The brand affinity module 206, which may be included in the brand affinity system 146 of FIG. 1 and/or in the user experience system 143 of FIG. 1, may be configured to calculate affinity values for pairs of brand names. Affinity between two brands may be determined based on correlation of transactions (e.g., purchases) with respect to item listings that include the brand name and transactions with respect to item listings that include the further brand name, by the same user in the on-line trading platform. Example operations performed by the system 200 are described with reference to FIG. 3.

FIG. 3 is a flow chart of a method 300 to customize user experience based on brand resilience data, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1.

As shown in FIG. 3, the method 300 commences at operation 310, when the new session detector 202 of FIG. 2 detects commencement of a user session in the on-line trading platform. As stated above, the first search request in a user session is referred to as an initial search request. The presence or the absence of a reference to a brand name in the initial search request is used to identify the session as a branded session or as not a branded session. At operation 320, the session type module 204 examines the initial search request in a user session and determines whether the initial search request includes a phrase that represents a brand name at operation 330. At operation 340, if the initial search request includes a phrase that represents a brand name, the brand resilience module 206 examines brand resilience value assigned to the brand name. As explained above, the brand resilience value for the brand name may be calculated as a function of brand popularity value for the brand name and the on-click percentage value for the brand name.

At operation 350, the search strategy selector 208 selects, based on the brand resilience value determined or accessed by the brand resilience module 206, a search strategy for the user session. As described above, some examples of search strategies include a brand-focused search strategy and a brand-neutral strategy, where the brand-focused search strategy entails presenting item listings associated with the brand name and omitting presenting item listings associated with further brand names that are distinct from the brand name, while the brand-neutral strategy entails presenting item listings associated with the brand name and also presenting item listings associated with one or more further brand names that are distinct from the brand name.

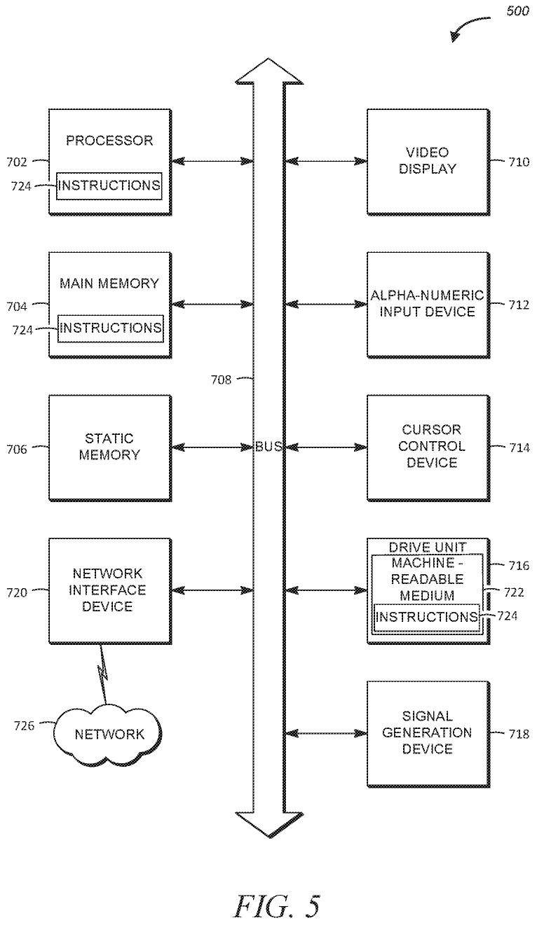

FIG. 5 is a diagrammatic representation of a machine in the example form of a computer system 700 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 707. The computer system 700 may further include a video display unit 710 (e.g., a liquid crystal display (LCD) or a cathode ray tube (CRT)). The computer system 700 also includes an alpha-numeric input device 712 (e.g., a keyboard), a user interface (UI) navigation device 714 (e.g., a cursor control device), a drive unit 716, a signal generation device 718 (e.g., a speaker) and a network interface device 720.

The drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, with the main memory 704 and the processor 702 also constituting machine-readable media.

The software 724 may further be transmittal or received over a network 726 via the network interface device 720 utilizing any one of a number of well-known transfer protocols (e.g., Hyper Text Transfer Protocol (HTTP))).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like. Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system to customize user experience based on brand resilience data has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1-20. (canceled)

21. A method for identifying relevant item listings during on-demand branded sessions corresponding to on-demand brand resilience values, the method comprising:
receiving a first search request having a keyword that represents a brand name, wherein the keyword is configured for on-demand brand resilience evaluation;
based on the keyword representing the brand name, initiating a user session as an on-demand branded session;
for the on-demand branded session, determining an on-demand brand resilience value as a brand resilience value of the brand name, wherein the brand resilience value indicates an importance of the brand name to the user session, wherein during the user session, the on-demand brand resilience value is determined utilizing a number of clicks on references to one or more item listings that include the brand name;
detecting a second search request;
based on the on-demand brand resilience value of the brand name for the user session, identifying item listings for the second search request, wherein the item listings are identified from a plurality of item listings that are responsive to the second search request; and
communicating the item listings for presentation.

22. The method of claim 21, the method further comprising:
configuring the brand name for the on-demand brand resilience using at least one of the brand name, a brand name synonym, an official name, a misspelling of the brand name, a familiar short name, a brand phrase, and an abbreviation;
determining that the keyword represents the brand name; and
determining that the keyword is configured for the on-demand resilience evaluation.

23. The method of claim 21, the method further comprising:
in real-time, receiving the number clicks on the references to the one or more item listings that include the brand name; and
based on the number of clicks, calculating the on-demand brand resilience value.

24. The method of claim 21, wherein the item listings identified for the second search request are listings that comprise the brand name.

25. The method of claim 21, wherein when the on-demand brand resilience value of the brand name is characterized by high resilience, the item listings are predominantly associated with the brand name.

26. The method of claim 21, the method further comprising:
determining that the on-demand brand resilience value of the brand name is characterized by low resilience; and
identifying the item listings for the second search request without consideration for the brand name.

27. The method of claim 21, wherein presentation of the item listing is performed in real-time during the on-demand branded session, wherein the brand name identifies a type of product manufactured by a particular company under a particular name.

28. A system for identifying relevant item listings during on-demand branded sessions corresponding to on-demand brand resilience values comprising:
one or more processors; and
a machine-readable hardware storage device coupled with the one or more processors, the machine-readable hardware storage device storing instructions that, when executed by the one or more processors, cause the system to perform operations comprising:
receiving a first search request having a keyword that represents a brand name, wherein the keyword is configured for on-demand brand resilience evaluation;
based on the keyword representing the brand name, initiating a user session as an on-demand branded session;
for the branded session, determining an on-demand brand resilience value as a brand resilience value of the brand name, wherein the brand resilience value indicates an importance of the brand name to the user session, wherein during the user session the on-demand brand resilience value is determined utilizing a number of clicks on references to one or more item listings that include the brand name;
detecting a second search request;
based on the on-demand brand resilience value of the brand name for the user session, identifying item listings for the second search request, wherein the item listings are identified from a plurality of item listings that are responsive to the second search request; and
communicating the item listings for presentation.

29. The system of claim 28, the operations further comprising:
configuring the brand name for the on-demand brand resilience using at least one of the brand name, a brand name synonym, an official name, a misspelling of the brand name, a familiar short name, a brand phrase, and an abbreviation;
determining that the keyword represents the brand name; and
determining that the keyword is configured for the on-demand resilience evaluation.

30. The system of claim 28, the operations further comprising:
in real-time, receiving the number clicks on the references to the one or more item listings that include the brand names; and
based on the number of clicks, calculating the on-demand brand resilience value.

31. The system of claim 28, wherein the item listings identified for the second search request are listings that comprise the brand name.

32. The system of claim 28, wherein when the on-demand brand resilience value of the brand name is characterized by high resilience, the item listings identified for the second search request are predominantly associated with the brand name.

33. The system of claim 28, the operations further comprising:
determining that the on-demand brand resilience value of the brand name is characterized by low resilience; and
identifying the item listings for the second search request without consideration for the brand name.

34. The system of claim 28, wherein presentation of the item listing is performed in real-time during the on-demand branded session, wherein the brand name identifies a type of product manufactures by a particular company under a particular name.

35. A non-transitory machine-readable hardware storage device for identifying relevant item listings during on-demand branded sessions corresponding to on-demand brand resilience values storing a set of instructions that, when executed by a processor of a machine, causes the machine to perform operations comprising:
receiving a first search request having a keyword that represents a brand name, wherein the keyword is configured for on-demand brand resilience evaluation;
communicating the first search request to cause a server to perform operations comprising:
based on the keyword representing the brand name, initiating a user session as an on-demand branded session;
for the on-demand branded session, determining an on-demand brand resilience value as a brand resilience value of the brand name, wherein the brand resilience value indicates an importance of the brand name to the user session, wherein during the user session, the on-demand brand resilience value is determined utilizing a number of clicks on references to one or more item listings that include the brand name;
detecting a second search request;
based on the on-demand brand resilience value of the brand name for the user session, identifying item listings for the second search request, wherein the item listings are identified from a plurality of item listings that are responsive to the second search request;
communicating the item listings for presentation; and
causing presentation of the item listings.

36. The storage device of claim 35, the operations further comprising:
configuring the brand name for the on-demand brand resilience using at least one of the brand name, a brand name synonym, an official name, a misspelling of the brand name, a familiar short name, a brand phrase, and an abbreviation;
determining that the keyword represents the brand name; and
determining that the keyword is configured for the on-demand resilience evaluation.

37. The storage device of claim 35, the operations further comprising:
in real-time, receiving the number clicks on the references to the one or more item listings that include the brand names; and
based on the number of clicks, calculating the on-demand brand resilience value.

38. The storage device of claim 35, wherein the item listings identified for the second search request are listings that comprise the brand name.

39. The storage device of claim 35, wherein when the on-demand brand resilience value of the brand name is characterized by high resilience, the item listings identified for the second search request are predominantly associated with the brand name.

40. The storage device of claim 35, the operations further comprising:
determining the on-demand brand resilience value of the brand name is characterized by low resilience; and
identifying the item listings for the second search request without consideration for the brand name.
